(19) United States
(12) Patent Application Publication
(10) Pub. No.: US 2006/0286279 A1
(43) Pub. Date: Dec. 21, 2006

(54) Textured food product

(76) Inventors: Jennifer Eastman, Sacramento, CA (US); Gloria Lee, Sacramento, CA (US); Zachary S. Wochok, Davis, CA (US)

Correspondence Address: MCDONOUGH, HOLLAND & ALLEN, 555 CAPITOL MALL, 9TH FLOOR, SACRAMENTO, CA, 95814, US

(21) Appl. No.: 11/142,520

(22) Filed: Jun. 1, 2005

(51) Int. Cl. A23J 1/00

(52) U.S. Cl. 426/656

(57) ABSTRACT

Textured food product having a rice protein content of between about 10% and about 90% by dry weight and low off flavor.

### BACKGROUND OF THE INVENTION

1. Field of the Invention

The present invention relates to textured food products, and, in particular textured food products having a high rice protein content.

2. Description of Related Art

Texturized proteins are a growing segment of the nutritional ingredient market. Textured proteins can be manufactured into food products of just about any shape, size and density, by controlling the parameters of the manufacturing process, such as extruder types, conditions and die orifices. Textured soy products made from soy flours, isolates and concentrates have been produced for decades for use as inexpensive meat extenders and replacers, though texturized soy products have gradually been adopted for other purposes, including alternative protein sources for the manufacture of snack foods, and increasingly, to produce high protein or high energy health food products.

Textured food products are manufactured from powder mixtures of cereal flours (wheat, rice, oats, etc.), and/or carbohydrates (i.e. starches, flours, etc.) and/or legumes and/or protein powders (protein powders, protein concentrates, protein isolates), typically combined with small amounts of malt, fat, sugars, emulsifiers and salt. Cooking is accomplished at relatively high moistures, using a combination of steaming and extrusion cooking through a single screw or twin screw extruder. After cooking the product is dried to a moisture content generally less than 5%.

The end product of the extrusion process includes various textured food products, from meat analogs, to crisps, nuggets, crackers and various cereal-type products, which may be produced of a single grain, or from various combinations of grains, legumes, carbohydrates, proteins and other minor ingredients. Extruded cereal-type products find many uses, from conventional ready-to-eat consumer cereal applications, to various snack and nutritional bar applications.

Textured food products can be produced in different sizes and shapes and have protein contents that generally range anywhere from 10%-90%. By controlling the extrusion admixture or the processing parameters in the extruder, such as by varying moisture content, screw speed and feed rate, food processors can vary the density of crisps, or even how they interact in a bar matrix. These crisps or nuggets are beginning to be available in protein sources other than soy.

Soy proteins and dairy proteins are increasingly being used for such high protein snack applications. When the proteins are extruded into expanded shapes, they are valued for their ability to provide texture as well as increasing the overall protein content or protein quality of the finished food product.

Soy proteins, while they are now available in various forms, including concentrates and isolates with increasingly acceptable flavors, have numerous unresolved issues related to their “beany” flavor. Soy protein is also ranked high among foods in terms of allergenicity. Consumers with allergies to soy must avoid all soy products, including isolated soy protein and textured soy protein (TSP), also known as textured vegetable protein (TVP), and any products containing the above.

Whey can enhance certain flavors and help flavors to carry through in baked goods. Textured whey protein products have also been proposed as an alternative to soy for the reason of having a cleaner flavor in some respects, though whey has other, detrimental flavors that must be contended with. U.S. Pat. No. 6,607,777 describes textured whey protein products and methods for their production. Milk, however, is also considered a very allergenic food. Whey proteins are also difficult to extrude, because of their tendency to burn.

Other plant proteins are available in concentrated forms, but each presents unique challenges with regard to issues such as functionality, flavor and allergenicity. For textured pieces, higher protein content mixes expand less efficiently, and are increasingly dependent upon interaction with carbohydrate ingredients for uniform expansion. Depending on the protein source, different additional ingredients are required for efficient expansion of the finished product, and what is suitable for soy or whey may produce an unacceptable product using a different protein.

Wheat proteins have the advantage of contributing to the natural wheat flavor that most baked products target, though the wheat flavor is less desirable for other applications. In any case, wheat proteins are not widely used for extrusion products.

In the world of proteins there are not many that are truly hypoallergenic. Rice protein concentrates are available as powders, and have been used as fortifiers to food or as nutritional supplements. They are promoted as providing a nutritious protein source that is relatively free from the allergens commonly associated with soy, milk and other grains. Rice protein has an excellent amino acid profile, reasonably close to that found in mothers milk. Rice protein is also highly digestible and low in ash. Rice proteins are relatively new, however, and there has been little opportunity to work with such proteins in producing textured food products.

Concentrated rice protein is an inherently bitter product, however, making it difficult to formulate into mainstream food products, particularly when used at high percentage of the food formulation as in extruded or textured food products. Once the structure of the rice grain is disrupted lipase enzymes attack the rice oil and create free fatty acids, such that milled rice becomes rancid very quickly, affecting the taste of the rice, and any rice products produced from the milled rice.

For this reason, most applications for rice proteins are as ingredients at a relatively low concentration, or as fortifiers or supplements. When used as a fortifier, rice protein is never used as the main ingredient of the food, and is only present to the extent that various bitter, rancid and other off-flavors can be masked. It is clear to see why no textured food products are available that represent a high amount of rice protein; even though progress has been made for the extraction of rice protein, i.e., processes for how to separate the protein fraction from the rice kernel.

Thus, while the primary reason that rice protein has not been used as a feature ingredient in extruded products in the past is commercial availability, a secondary issue is flavor, as natural bitter compounds present in the soluble fraction, as well as oxidized fatty acids, are concentrated with the protein such that rice protein concentrates have a high level of off-flavors and are inherently bitter.

There remains a need, then, for new sources of textured protein products which can provide a high protein food ingredient and overcome the myriad issues of flavor, rancidity and allergenicity.

### SUMMARY OF THE INVENTION

The present invention provides a textured food product having a rice protein content of between about 10% and about 90% by dry weight. In a further embodiment the rice protein content is at least about 30% by dry weight. In a still further embodiment the rice protein content is at least about 50% by dry weight, while in another still further embodiment the rice protein content is at least about 70% by dry weight.

The rice protein preferably comprises about 50% or greater of the total protein content in the product. In a further embodiment the product has a density of between about 0.1 g/cc and about 0.4 g/cc and a moisture content of less than about 7%. In one preferred such embodiment the product has a density of less than about 0.3 g/cc. In a different preferred embodiment the product has a moisture content of less than about 5%.

In one aspect of the invention the rice protein ingredient is selected from the group consisting of rice protein concentrates, rice protein isolates and mixtures thereof. In a preferred embodiment of this aspect the rice protein ingredient has a reduced hexanal of less than about 15,000 ppb, when measured through head space analysis. In a further preferred embodiment the rice protein ingredient has a reduced hexanal of less than about 10,000 ppb, or more preferred, less than about 7,500 ppb, when measured through head space analysis.

In another aspect of the invention, the product comprises from about 40% to about 100% of the rice protein ingredient, by dry weight. In a further embodiment the rice protein is about 60% or greater of such rice protein ingredient. In another aspect, the rice protein ingredient is present at about 75% or greater, and in a still further aspect, about 90% or greater. In one aspect of the invention a rice protein concentrate having at least about 70% rice protein is used. In a further aspect a rice protein concentrate having at least about 80% rice protein. The rice protein concentrate used in a still further aspect is Remypro N80+. Remy, a Belgian company, produces Remypro N80+, which is available in the United States from A&B Ingredients (Fairfield, N.J.).

The rice protein ingredient preferably supplies substantially all of the rice protein in the product. In a further embodiment the rice protein is predominantly insoluble rice protein, though it may comprise a blend of soluble and insoluble rice proteins. In a preferred such embodiment, the rice protein comprises from about 50% to about 90% insoluble rice protein.

A second protein-containing ingredient may be incorporated in the product, where the second protein-containing ingredient is not rice protein, and where the second protein-containing ingredient contributes about 50% or less of the total protein of the product. In one such embodiment, a high lysine containing ingredient is used as the second protein containing ingredient. In a further embodiment the high lysine containing ingredient is selected from the group consisting of protein powders, protein concentrates, protein isolates, high protein flours, purified lysine and mixtures thereof. In one aspect a flour selected from the group consisting of soybean flour, fava bean flour, lentil flour, pea flour, chickpea flour, lentil flour, lupin flour, quinoa flour, amaranth flour and mixtures thereof is the high lysine containing ingredient. In another aspect the high lysine containing ingredient is selected from the group consisting of whey powder, whey concentrate, whey isolate, soy concentrate, soy isolate and mixtures thereof. In a preferred such aspect, purified lysine is used, preferably in the form of a lysine monohydrate salts, at about 1% to about 8% of the product, by dry weight. Preferably the lysine comprises between about 4% and about 10% of the total amino acids, and even more preferably, the lysine comprises at least about 7% of the total amino acids.

The extruded product preferably has low rancidity, with low off flavor, preferably, very low off flavor, and more preferably, extremely low off flavor, as represented by having a peroxide value of about 10 meq/kg or less, about 5 meq/kg or less, and about 2 meq/kg or less, respectively, or a hedonic test score of at least about 6, preferably at least about 7, and even more preferably at least about 8, respectively, on a hedonic scale of 0 to 10.

In a further embodiment the product may comprise from about 10% to about 70% by dry weight of a carbohydrate or other edible polysaccharide, (i.e., sugar, starch or fiber). Rice flour, rice starch, wheat flour, wheat starch, oat flour, tapioca starch, potato starch, corn starch and mixtures thereof are preferred carbohydrates.

In a different aspect, the product may comprise from about 5% to about 15% by dry weight of a sweetener, preferably a sweetener selected from the group consisting of brown rice syrup, malt extract, honey and fruit juice concentrate. The sweetener may also be sucrose, fructose, dextrose or maltose.

In a still further aspect, the product may comprise from about 1% to about 50% by dry weight of a dietary fiber, which may be soluble, insoluble, or a combination of fibers.

The product may comprise rice protein derived from rice having a trait selected from any of genetically engineered rice, organically grown rice and non-genetically modified rice.

The invention further provides a ready to eat cereal, a snack product, a nutrition bar, snack bar, energy bar or a confectionary product comprising the textured rice protein product.

In a different aspect, the invention provides a method for preparing an extruded textured food product comprising the steps of: a) admixing a rice protein containing ingredient with a starch containing ingredient in a sufficient amount to provide a textured product having a rice protein content of between about 10% to about 90% by dry weight; b) extruding the admixture through an extruder under conditions to produce pieces that expand upon extrusion and form a textured food product; and c) drying the textured food product pieces.

In one preferred method the admixture is heated to a temperature of between about 28° C. and about 180° C., under a pressure ranging from about 100 bar to about 300 bar, through the extrusion process. In one further preferred method the pressure is at least about 250 bar. In a further embodiment the admixture has a moisture content ranging from about 15% to about 40%. The extruder may be a single screw or twin screw extruder, or other extruder system known to the art.

In a preferred embodiment of the invention the extruder has die orifice capable of forming the textured food product pieces into a shape selected from the group of shapes consisting of spheres, ovoids, strands, ribbons, flakes, and rings.

These and other features and advantages of this invention are described in, or are apparent from, the following detailed description of various exemplary embodiments of the devices and methods according to this invention.

### BRIEF DESCRIPTION OF THE DRAWINGS

Various exemplary embodiments of this invention will be described in detail, with reference to the following figures, wherein:

FIG. 1 is a table with the amino acid content for whey (dairy) protein, mothers milk and various plant proteins for use in the invention.

### DETAILED DESCRIPTION OF THE INVENTION

In describing and claiming the present invention, the following terminology will be used in accordance with the definitions set out below.

As used herein, “comprising,” “including,” “containing,” “characterized by,” and grammatical equivalents thereof are inclusive or open-ended terms that do not exclude additional, unrecited elements or method steps. “Comprising” is to be interpreted as including the more restrictive terms “consisting of” and “consisting essentially of.”

As used herein, “consisting of” and grammatical equivalents thereof exclude any element, step, or ingredient not specified in the claim.

As used herein, “consisting essentially of” and grammatical equivalents thereof limit the scope of a claim to the specified materials or steps and those that do not materially affect the basic and novel characteristic or characteristics of the claimed invention.

As used herein, “textured food products” means high protein textured food products typically prepared commercially by thermoplastic extrusion of flours, grits and protein concentrates or isolates under heat and pressure to form chips, crisps, chunks, flakes, and a variety of other shapes. Their structure and texture can be modified by the type and relative amount of the carbohydrate ingredient, by varying the extrusion parameters and by the addition of salts to the mix before extrusion. Textured food products also absorb water, and to some extent fat, so they can be regarded as having physical functions, in addition to their main roles as providing texture, extenders and sources of protein. Textured food products may be produced by various methods known to the art, generally through a process of extrusion of a high temperature admixture under pressure, resulting in an expanded product which is dried to provide the textured food product. The extruder can be adapted with a number of different die orifices, for forming the textured food product pieces into a shapes like spheres, ovoids, strands, ribbons, flakes, and rings, to provide desired shapes.

The rice protein preferably comprises about 50% or greater of the total protein content in the product, and it will have a density ranging between about 0.1 g/cc and about 0.4 g/cc, with a moisture content of less than about 7%. Lighter, crunchier products will have a density of less than about 0.3 g/cc and a moisture content of less than about 5%.

Rice protein content of “high protein” products will vary between about 10% and about 90% by dry weight. High protein applications, like high protein bars or snack foods, may require a rice protein content of at least about 30% by dry weight or greater. Textured food products of 50% rice protein or greater may be produced by using a rice protein concentrate of 80% rice protein at about 60% as an ingredient at about 60% of the product. If using a rice protein concentrate as an ingredient of about 80% or greater, the rice protein content will be 70% in the final product. Textured food products with higher protein content, in the range of 60% to 90% rice protein content by dry weight, may require the use of rice protein isolates.

As used herein, “snack products” includes various ready to eat cereals, nutrition bars, salad and ice cream toppings, or confectionery products comprised of the textured food products. The manner of incorporation of the textured food products is based primarily on specific food formulation, processing equipment and the type of ingredient used. Where the textured food product is intended to contribute to mouth feel or chewing sensation, the textured food product is typically light, crisp and crunchy in texture. The textured food products can be used in products such as:
chocolate bars, granola bars, nutritional bars, snack bars, energy bars and yogurt clusters to add crunch;
snack, granola and trail mixes to give a light crunchy texture; and
baked goods, ice cream, and frozen yogurt as a crunchy topping.

As used herein, “rice protein ingredient” means concentrated sources of rice protein, including high protein rice flours, rice protein concentrates, rice protein isolates and mixtures thereof. Protein concentrate usually refers to a protein supplement source which has been concentrated through high heat drying (dehydration), acid extraction or filtration to reduce the original source to a more concentrated protein commodity. This is the least expensive method of protein extraction, but may contain some impurities, as well. Concentrates are usually between 60 to 80 percent protein by dry weight.

Isolates are created through membrane based separation technology, an alcohol wash or a water wash or some ionization concentration techniques. The objective is to separate additional carbohydrates and fats from the protein. The water method is the least expensive and the ionization technique is the most expensive method. The isolate is then filtered to further purify the protein fraction. Isolates are a minimum of 90% protein on a dry basis.

Rice protein concentrate can be made through a process of removing a portion of the carbohydrates from dehulled and defatted rice. Rice protein concentrate should contain at least 60% protein on a dry-weight, or moisture free, basis. The protein can have different solubility characteristics, depending on the extraction method. Some applications, such as beverages, require a highly soluble protein. The rice protein concentrate made with an alcohol wash will have low solubility.

Rice protein isolate has the highest content of protein. Rice protein isolate is made in a manner similar to that for other protein isolates.

Rice protein concentrate is commercially available from a variety of sources as a by-product of rice starch and rice syrup manufacturing. California Natural Products (Lathrop, Calif.) supplies both a 50% and a 70% rice protein concentrate. RPC50XFG and RPC70XFG are concentrates with low residual sugars produced by filtering protein and fiber from whole rice digested enzymatically to produce rice syrups. Both products are promoted for protein fortification of cookies, muffins and breads, and as a fine mesh powder for addition to of dry mixes or prepared foods.

Remypro N80+ is an all-natural rice protein concentrate which is approximately 80% or greater rice protein, on a dry weight. Remypro N80+ has a very fine particle size, white to amber in color, and, and due to a new processing method, an even cleaner taste than the original product. Remypro N80+ has a fat content of about 5%, as measured by solvent extraction. The product is extracted during rice starch production, obtained by wet milling, sieving, separation, concentration and drying. It is insoluble in water, non-allergenic and with an amino acid profile purportedly close to that of mother's milk (Table 1). Thus, the selling points of rice protein are that it is considered relatively hypoallergenic (very few individuals have allergy to rice), and has a desired amino acid profile.

Remy also produces Remypro N70+, a similar rice protein concentrate that contains a minimum of 70% rice protein.

The textured food product will typically contain about 40% to about 100% of the rice protein ingredient, by dry weight. The rice protein ingredient preferably supplies substantially all of the rice protein in the product.

Insoluble rice protein is the predominant protein of most concentrates, though in some applications it may be desirable that the rice protein ingredient comprise a blend of soluble and insoluble rice proteins. Remypro RHP75, manufactured by Remy, is a soluble rice protein concentrate, produced from food grade, soluble endosperm rice protein. Generally the rice protein will comprise greater than 50%, more typically as much as 90% or more insoluble rice protein.

The rice protein may be derived from genetically engineered rice. Attempts to engineer grain crops often focus on manipulating the amino acid profile, and rice varieties having modified or unique nutritional profiles may be preferred for some applications. Changes to vitamin content, protein types or relative levels of amino acids, or altered fatty acid or starch composition are all possible, as well as the more commonly provided resistance to chemicals, pests, and increased yields.

For purposes of certifications, such as Kosher or organic certifications, organically grown rice or non-genetically modified rice may be preferred, though rice is an inherently Kosher ingredient as such.

Off flavors include any objectionable taste, lingering after-taste, odor or sensation that reduces the palatability of the product. Off flavors are often developed through the process of lipid oxidation, leading to rancidity. According to Merriam Webster, rancid is defined as: “having a rank smell and taste”.

As soon as rice is milled, it begins to undergo a variety of chemical and physical changes. Oxidation of lipids is one common and frequently undesirable chemical change that may produce off flavors in rice oil, bran or rice protein concentrates. Lipid oxidation produces a variety of volatile compounds including hydrocarbons, aldehydes, enals, dienals, ketones, and organic acids. Lipid oxidation products correlate with bitter, rancid or off flavors. Some of the more common problematic lipid oxidation products include pentanal, hexanal, heptanal, and 2-heptanone, and furans such as 2-ethylfuran, n-butylfuran, and pentylfuran.

Various tests are known to the art for assessing lipid oxidation and correlating product quality and off flavors to lipid oxidation levels. The tests are most commonly performed by producers of oils as part of the quality control process, but oil rancidity can affect other foods as well. For testing foods the oil fraction is typically first extracted and then subjected to one or more of the lipid oxidation tests.

Hexanal is a common volatile produced during lipid oxidation that is commonly measured by gas chromatographic analysis. A portion of the product is heated and a gas sample withdrawn from the headspace over the sample. The headspace sample is then injected onto a GC column to separate hexanal from other volatile components. Hexanal concentrations can vary widely depending on a number of factors including sample history, fat content, and fat composition. A variety of samples are used to establish a correlation between hexanal concentration and product quality. Once that correlation is established, hexanal measurement can be a rapid and useful tool for lipid oxidation measurement.

Other common analytical assessments of oxidation are the Iodine Value, Peroxide Value, Anisidine Value, and Totox Value. The Iodine Value measures the average number of double bonds of an oil, i.e., the value is a measure of unsaturation. The test measures the reaction of the double bonds with a halogen, in this case iodine. It expresses the concentration of the unsaturated fatty acids, together with the extent to which they are unsaturated, in a single number, and therefore is a simple and very useful quality parameter. Iodine value is the percentage of iodine absorbed by the oil or fat under the conditions of the test.

Peroxides in oxidized oils are unstable intermediates, which decompose into various carbonyl and other secondary oxidation products, principally 2-alkenals and 2,4-dienals. This decomposition accelerates as oxygen is introduced and as temperature is raised, factors that are common in the milling process. The peroxide value (PV) of an oil reflects the degree of its oxidation taking place. The PV test, which is one of the most common tests used to evaluate the extent of lipid oxidation, is based on measuring peroxides, typically based on an iodometric titration, which measures the iodine produced from potassium iodide by the peroxides present in the oil. The PV is expressed as milli-equivalents of oxygen per kilogram (meq/kg). High peroxide values are a definite indication of a rancid fat, but moderate values may result from the depletion of peroxides after reaching high concentrations.

The Anisidine Value (AV) assay measures the high-molecular weight saturated and unsaturated carbonyl compounds. The AV represents the level of aldehydes, principally 2-alkenals, present in the oils. As the PV is non-linear in nature, meaning that it does not increase in a linear fashion over time, the AV is sometimes used to assay for freshness of an oil.

The Totox Value is used as a measure of the precursor non-volatile carbonyls present in a processed oil, plus any further oxidation compounds developed during storage. This value is determined by the following formula: Anisidine Value +2PV.

A single lipid oxidation test may not always correspond to off flavors. Peroxide values could be low because minimal oxidation has occurred or because peroxide concentrations have begun to decrease. Low aldehyde concentrations may be the result of limited oxidation or the aldehydes may have volatilized. It is generally not possible to predict the best indicator of lipid oxidation and any attempt to characterize rancidity of a product will likely require multiple tests.

The fatty acid and lipid composition of rice oil makes it a highly unstable oil that generates high PV and AV values when processed. This can lead to strong odors and tastes. The quality characteristics of good quality refined rice bran oil have a PV of less than about 1.0 meq/kg, and an iodine value in the range of 110 or less.

Oxidation is only one parameter in determining rancidity, however, and having a low PV or AV value is not a guarantee that there will be no off flavors. On the other hand, an oil with low off flavor will almost always have a good PV and AV value. Also, what ranks as ‘good’ and ‘bad’ levels of PV or AV will depend on the oil, as some types of oil will taste acceptable with PV of 10 meq/kg, whereas others will taste very bad at 5 meq/kg. This depends on the oil composition, fatty acid distribution, other components present in the lipids.

For a rice protein product, the oil comprises a small fraction of the overall composition. For this reason, a textured food product produced with rice protein ingredients may be acceptable with a PV for the rice protein ingredient of 10 meq/kg for some applications (low off flavor), though values of 5 meq/kg or less may be preferred in sensitive applications where the textured food product has a high percentage of rice protein (very low off flavor). Where the final application will have a substantial component of the textured food product, the preference will be textured food products having extremely low off flavors, a PV value of about 2 meq/kg or less, to as little as 1 meq/kg or less.

It is not just rancidity that contributes to off flavors. Rice has a number of naturally occurring bitter compounds that may be concentrated with the protein. For this reason, off flavor in rice protein ingredients or products may be more advantageously evaluated using sensory evaluation methods. These methods may be subjective or objective. Subjective tests involve trained panelists, while objective testing employs the use of lab instruments with no involvement of the human senses.

A subjective evaluation method well known to the art is the hedonic test, used for evaluating the quality of a food through the human senses, i.e. taste, smell, sight, touch and hearing. Many other objective and subjective sensory tests are used in the sensory evaluation of food products, and are well known to the art. The choice of test may depend on the intended application for the food. For instance, in same applications the sight and texture of the product may be as important as taste and smell, while in other applications, hedonic tests focusing on the latter will be sufficient. They all may be used to provide an assessment of the level of off flavors in an ingredient or product.

The Hedonic scale method measures the level of the liking of foods, or any other product. The test relies on a subject's ability to communicate feelings of like or dislike about a product. Hedonic testing may be used with untrained as well as experienced panel members. In Hedonic testing, samples are presented in succession and the subject is told to decide how much he or she likes or dislikes the product and to mark the scales accordingly. The Hedonic scale is anchored with different categories ranging from like extremely to dislike extremely. Many different forms of the scale may be used. A scale of 1 to 9 will provide 9 categories, while 0 to 10 provides 11 separate categories. In both scales a score of 5 will represent a sensory evaluation that is equally weighted between like and dislike.

For a rice protein product, using a scale of 0 to 10, the textured food product produced with rice protein ingredients may be acceptable with a Hedonic test score 6 for some applications (low off flavor), though values of 7 or more may be preferred in sensitive applications where the textured food product has a high percentage of rice protein (very low off flavor). Where the final application will have a substantial component of the textured food product, preferred will be textured food products having extremely low off flavors, a Hedonic test score of about 8 or more, to as much as 9.

Example 3 demonstrates that textured food products are not produced having low, very low or extremely low off flavors, unless a rice protein ingredient is used having low hexanal values, reflective of low rancidity and careful processing. Product lines of the 600 series are produced with the low rancidity rice protein concentrate. Textured vegetable products using the new process rice protein concentrate had hedonic test scores of greater than 6 (low off flavor), with some achieving a test score of 8, reflecting extremely low off flavor.

There are nine amino acids that are considered essential for human nutrition (called “essential” amino acids): histidine, isoleucine, leucine, lysine, methionine, phenylalanine, threonine, tryptophan, and valine. Eleven amino acids can be made by the body itself, termed “nonessential”. The nonessential amino acids are arginine, alanine, asparagine, aspartic acid, cysteine, glutamine, glutamic acid, glycine, proline, serine, and tyrosine.

Semi-essential amino acids are those that may be synthesized in the human body if conditions are right. Arginine and histidine can be converted from other amino acids if needed. Methionine can be converted to cysteine, but cysteine cannot be converted to methionine. Phenylalanine can be converted to tyrosine, but not the other way around. Therefore, when cysteine and tyrosine are present in the diet, the requirements for methionine and phenylalanine are reduced. Thus, cysteine and tyrosine are sometimes classified as “semi-essential.” The liver is able to produce 80% of the amino acids it needs for protein construction, while the remaining 20% must be consumed.

Most commonly histidine is classified as semi-essential, for while it can be produced in small amounts within the adult body, dietary sources are still acknowledged as being desirable. It is sometimes considered an essential amino acid for children, but not for adults.

The amount of protein and relative amounts of the various amino acids are sometimes used to evaluate a protein's quality. Protein nutritional quality is generally determined by three factors: essential amino acid composition, digestibility, and amino acid requirements. In addition, the food system and companion protein quality need to be considered.

In 1985 the Food and Agriculture Organization of the United Nations/World Health Organization (FAO/WHO) issued a set of suggested ideal patterns for essential amino acids for different age groups (Food and Agricultural Organization/World Health Organization/United Nations University (FAO/WHO/UNU) (1985), “Report of Expert Work Group on Energy and Protein Requirements,” WHO Technical Report Series No. 724, WHO Publication Center, Albany, N.Y., 12210).

Plant proteins are often considered to be of lower quality than animal proteins, mainly because they have a lower content of certain essential amino acids. Grains tend to be low in lysine, while beans and other legumes, while higher in lysine, tend to be lower in the sulfur amino acids, particularly methionine. Humans under age two have the greatest protein needs, on a per kg of body weight basis. For this reason, soy-based infant formulas are often supplemented with methionine.

The absence of an ideal balance of essential amino acids for a particular foodstuff will not constitute a serious limitation for a diet containing a variety of food sources, such as cereals, legumes and animal proteins, eaten over the course of several meals. By blending proteins on a daily diet, a suitable balance of the essential amino acids is generally obtained. However, for certain food products, such as infant formulas, where the product is intended to comprise a complete meal or the main component of a dietary program, it may be desirable to provide a suitable balance of the essential amino acids within a single product. For vegetable-based protein products, a combination of soy or legume proteins with the protein of cereal grains is often used to bring the combined protein closer to dietary guidelines. Legume protein amino acid profiles (lysine rich, sulfur amino acid limiting) fit nicely with grain proteins for this purpose (lysine limiting, sulfur amino acid rich). The resulting “protein quality” if properly blended will be superior to either vegetable protein alone.

Food supplements, such as diet formulas, high protein bars or snack bars intended to be part of a special diet or weight-regulating program are all examples of specialized food products where a balancing of amino acids may be desired. For textured food products intended as the predominant protein source of such products, a second, non-rice, protein-containing ingredient may be incorporated in the textured vegetable product. Rice protein has advantages over many proteins in digestibility and allergenicity, and the second protein ingredient will generally be supplied at a level of 50% or less of the total protein of the product.

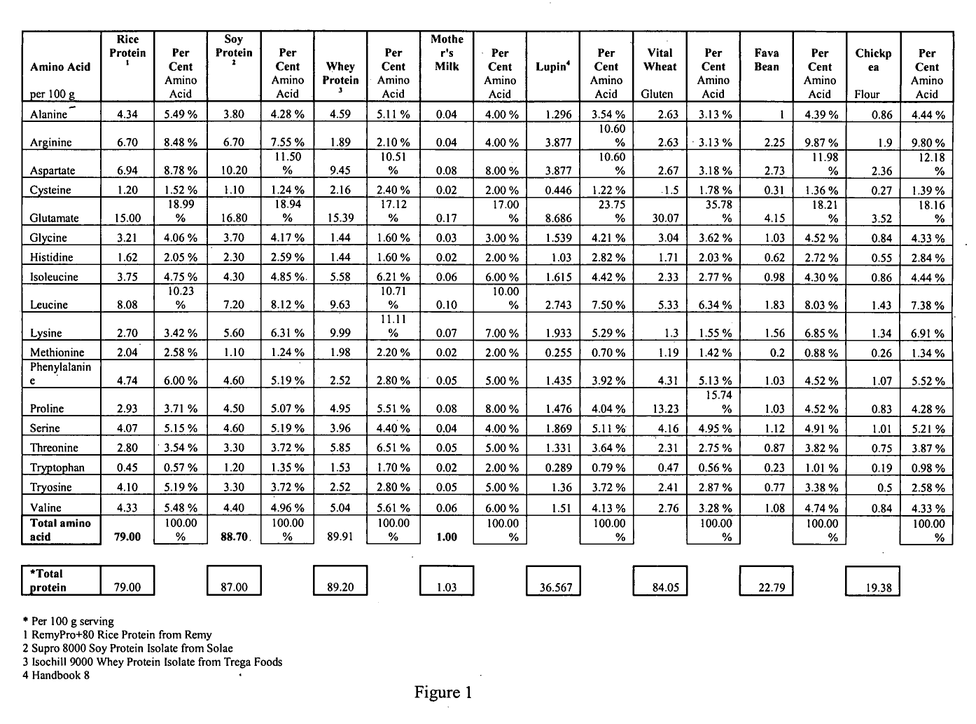

High lysine containing protein ingredients may be desired to balance off the relatively low concentration of lysine in the rice protein. High lysine containing ingredients will have about 5% or greater of the total amino acids in the form of lysine. Various protein powders, protein concentrates, protein isolates, high protein flours are known to the art that are high in lysine. The USDA annually produces a National Nutrient Database for Standard Reference that provides the amino acid content for various foods. Soybean flour, fava bean flour, lentil flour, pea flour, chickpea flour, lupin flour, quinoa flour, amaranth flour and mixtures thereof are all known to have a high lysine content. The amino acid profiles for several commonly used cereals and legumes are provided in FIG. 1. It should be kept in mind that these are natural products and variation in the same crop does occur in amino acid and other nutritional profiles from year to year and from variety to variety. Many of these have the advantage of being both non-animal in origin (for consumers having dietary restrictions) and low allergenicity. By “low allergenicity”, or “hypoallergenic” is meant that the product has little or no potential for eliciting a human allergic response. Concentrates and isolates derived from such sources are also increasingly available.

Animal sources of protein may also be used, such as whey and milk protein. There are three main forms of whey protein that result from various processing techniques used to separate whey protein: whey powder; whey concentrate; and whey isolate. FIG. 1 provides the amino acid composition of whey protein. Whey powder itself has several different varieties including sweet whey, acid whey (seen in salad dressings), demineralized (seen primarily as a food additive including infant formulas), and reduced forms. The demineralized and reduced forms are used in products other than sports supplements.

In some applications, purified lysine may be desired as the lysine containing ingredient. Lysine monohydrate salts (e.g., L-lysine monohydrochloride) can be added at about 1% to about 8% of the total product, by dry weight. Rice protein has lysine present at about 3.4% of the total amino acids (FIG. 1). Addition of 1% L-lysine monohydrochloride on a dry weight basis will raise the lysine level in the final textured food product to greater than 4%, while an addition of 8% L-lysine monohydrochloride (dry weight) will raise the lysine level in the textured vegetable product to about 10% of the total amino acids. Lysine is present in mother's milk, considered by many the ideal amino acid combination for protein, at a level of about 7%. L-lysine monohydrochloride added to rice protein at 4% will provide a textured food product with an amino acid profile very similar to mother's milk.

Various pulses or legumes (i.e. lentil, fava, soybean), in the form of flours, or their protein isolates or concentrates, as well as grains (i.e. wheat, corn, etc), their protein isolates or concentrates may be used to supplement lysine content of rice protein. Fava bean and chickpeas are particularly high in lysine, and may be used to produce a soy free, all vegetable product with high protein content and a protein quality approaching mother's milk. See FIG. 1. Seed crops such as amaranth, quinoa, and buckwheat are also relatively high in lysine, and flours, or protein concentrates and isolates, of these crops may also be used as the high lysine containing ingredient.

The product may comprise from about 10% to about 70% by dry weight of a carbohydrate or other edible polysaccharide. A carbohydrate is a molecule that consists of carbon, hydrogen and oxygen molecules. The types of molecules range from simple sugars to starches and other sugar complexes formed of fibrous polymers. These are often described in terms of “simple” or “complex” carbohydrates. Simple carbohydrates are composed of simple sugars or monosaccharides, such as glucose (dextrose) and fructose. Sucrose and lactose are disaccharides (two sugar molecules together). Polysaccharides consist of several sugars together in a chain and therefore are considered “complex” carbohydrates. Complex carbohydrates may be classified as either starches with alpha-glycosidic linkages, which are readily digested by intestinal amylases, or as dietary fiber with beta-linkages, which are resistant to these enzymes.

As used herein, “carbohydrate” includes various plant starches and starchy flours derived from grains, roots, corms, tubers and stems, such as rice flour, rice starch, wheat flour, wheat starch, oat flour, tapioca starch, potato starch, corn starch and modified variants thereof. Also included are various other edible polysaccharides and cellulosics, which may be natural, modified or synthetic, including celluloses and modified celluloses such as carboxymethylcellulose; dietary fibers, such as maltodextrin, inulin, fructo-oligosaccharides, pectin, and guar gum, and mixtures thereof. Various legume flours may also provide a source of carbohydrate. The consideration of a legume flour will be made both for its amino acid and carbohydrate contribution.

A certain percentage of carbohydrate will be required in various applications to control the processing functionality of the textured food product. For instance, a certain amount of carbohydrate is important for proper expansion of the textured food product. The type and amount of carbohydrate also may affect color, flavor and texture of the product.

For certain applications, from about 5% to about 15% by dry weight of a sweetener may be added to the textured food product. In addition to sweetness, sweeteners can add flavor and in some cases functionality to the food product. Sweeteners include various products having a high concentration of simple carbohydrates. Highly refined sweeteners include corn syrup, high fructose corn syrup, white sugar and brown sugar. Sugar or white sugar is made from sugar cane or sugar beets that have been chemically processed or refined to contain 99.9 percent sucrose. Brown sugar is white sugar with a bit of molasses added for color. Turbinado or raw sugar is made the same way as white sugar except for the last extraction of molasses. The standard for raw sugar is 96 percent sucrose. Molasses is a by-product of the manufacture of sugar from sugar cane, and includes light molasses, medium molasses and blackstrap molasses. Sorghum molasses is made from sweet sorghum, a grain related to millet.

Corn syrup is a chemically refined syrup made from corn. Dark corn syrup is artificially colored. High fructose corn syrup is made by an additional refining process that splits the two components of corn syrup. It has become a common ingredient of processed foods and beverages.

Highly refined carbohydrates have lower dietary fiber content, and are often avoided in low carbohydrate or high protein diets and diet products, as they are believed to have the greatest impact on blood glucose after ingestion. For these and other reasons, a natural sweetener such as honey, maple syrup, date sugar and fruit juice (e.g., raisin juice, pear juice, grape juice and apple juice), may be desired. Unrefined sweeteners are also made from natural foods like barley malt and sorghum. Brown rice syrup can be used where an all-rice textured food product is desired.

The carbohydrate fraction may include from about 1% to about 50% by dry weight of dietary fiber. Dietary fiber is the term for several materials derived from plants that the human body cannot digest. Fruits, vegetables, whole-grain foods and legumes are all considered good sources of dietary fiber.

Fiber is classified as soluble or insoluble. Soluble fiber dissolves in fluid in the large intestine and forms a gel. These fibers are believed to slow the passage of food through the digestive system, thereby slowing the absorption of simple sugars, which helps control the rise in blood sugar after eating. Soluble fiber has also been shown to help lower cholesterol levels. Good sources of soluble fiber include legumes, whole grains, particularly oats and barley, bran, such as oat bran and rice bran, and fruits and vegetables (apples, strawberries and pears, are especially good sources). High fiber products are also available as by-products of the fruit juicing industry, such as apple pulp.

Insoluble fiber doesn't dissolve in intestinal fluids, but instead soaks up water like a sponge, adding bulk and preventing constipation. Sources of insoluble fiber include fibers derived from fruits, vegetables, dried beans and-whole grain products.

The American Heart Association Eating Plan suggests eating foods high in both types of dietary fiber, but fiber remains deficient in many diets. Fibers derived from whole grains and legumes, such as soy, wheat, oat and barley, are often used as ingredient replacements in reduced-carbohydrate foods.

Higher protein content products generally have less expansion through a thermoplastic extrusion process, and are dependent upon interaction with carbohydrate for uniform expansion.

Other common ingredients may be added, including sodium chloride, flavoring agents, conditioners and expansion agents. Each ingredient must be considered for its impact on extrusion of the product. Minute additions of finely ground inert materials such as titanium dioxide, calcium silicate and calcium carbonate will result in expanded products with more uniform and even cell structure.

Generally, starch gelatinization increases with the increase of sugar content. Starches which are high in amylopectin, tend to produce a highly expanded, lighter product. Starches which are high in amylose content will produce a harder, dense product that is resistant to absorbing milk.

Sucrose added at levels above 15% will increase expansion. Sodium chloride levels above 5% will increase expansion, twice that of sucrose. Monoglycerides and diglycerides serve as emulsifiers and dough conditioners. Their use will result in drier dough creating less stickiness in the production of cereals.

Oils, fats, and lipids will significantly reduce expansion at levels above 5%.

### EXAMPLES

### Example 1

### Rice Protein Concentrate

RemyPro 80+ was provided in separate batches, before and after alterations to the development designed to improve the flavor of the rice protein ingredient, in particular, to remove a bitter off flavor. The batches before and after the process modifications are designated “old” and “new”, respectively

Head space analysis was conducted the old and new RemyPro 80+ rice protein ingredients. Measurements of the hexanal concentration from head space volatiles was performed in accordance with procedures known to the art. The protein processed with the old process had a head space hexanal value up to 18300 ppb. The protein processed with the new process had a head space hexanal value up to 7510 ppb.

### Example 2

### Extrusion of Textured Rice Protein Product

Textured rice protein products were made according to the present invention by extruding a raw mix rice protein concentrate and the additional ingredients described for Table 1, below. The admixture was produced using sufficient water to make a stiff dough, at an approximate ratio of 1 part water to 1.5-4 parts dry ingredients.

Extrusion was conducted using a Buhler twin screw extruder. In the Buhler twin screw extruder, dry feed and liquid are added separately and mixed in the barrel. The admixture was extruded through a die and the pieces were dried.

Extrusion parameters were: screw speed of 1500-2500 rpm, product temperature at the die of >180.degree. F., feed rate of 600-800 lb/hour, and water-flow rate of 180-400 lb/hour. Observations were made on color, opacity, structure, and texture for each collected sample. Collected samples were dried at room temperature overnight.

Table 1 lists provides information on the products made using rice protein concentrates.

TABLE 1

| | Rice | % Rice | | | | | | | |
|---|---|---|---|---|---|---|---|---|---|
| | Protein | protein | | | | | | | |
| | concentrate | concentrate | % Rice | other | % other | | | density | |
| Product | or isolate | or isolate | Flour | ingredient | ingredient | shape | moisture | (g/cc) | color |
| R-371 | CNP 50% | 60 | 40 | none | 0 | flakes | 4% max | 0.30-0.34 | white |
| | Pro | | | | | | | | |
| R-396* | RemyPro | 75 | 25 | none | 0 | c | | | |
| | 70+ | | | | | | | | |
| R-431 | RemyPro | 55 | 45 | none | 0 | crisps | 5% max | 0.165- | tan |
| | 70+ | | | | | | | 0.195 | |
| R-490 | RemyPro | 99.5 | 0 | ammonium | 0.5 | crisps | 5% max | 0.185- | light tan |
| | 80+ (old) | | | bicarbonate | | | | 0.215 | |
| R-500 | RemyPro | 90 | 0 | sweet rice | 10 | crisps | 5% max | 0.267- | light tan |
| | 80+ (old) | | | flour | | | | 0.297 | |
| R-521 | RemyPro | 45 | 0 | sweet rice | 10 | flakes | 5% max | 0.450- | tan |
| | 80+ (old) | | | flour | | | | 0.480 | |
| R-524 | RemyPro | 100 | — | — | — | crisps | 5% max | 0.247- | Light tan |
| | 80+ (old) | | | | | | | 0.277 | to tan |
| R-659 | RemyPro | 87.5 | 12.5 | — | — | crisps | 5% max | 0.198- | Light tan |
| | 80+ (new) | | | | | | | 0.238 | to tan |
| R-564 | RemyPro | 90 | 8 | Masking | 2 | crisps | 5% max | 0.345- | Light tan |
| | 80+ (old) | | | agent | | | | 0.375 | to tan |
| R-565 | RemyPro | 90 | 8 | Masking | 2 | crisps | 5% max | 0.375- | Light tan |
| | 80+ (old) | | | agent | | | | 0.405 | to tan |
| R-566 | RemyPro | 75 | 23 | Masking | 2 | crisps | 5% max | 0.431- | Light tan |
| | 80+ (old) | | | agent | | | | 0.461 | to tan |
| R-667 | RemyPro | 65.24 | 21.75 | Brown | 13.01 | crisps | 5% max | 0.200- | Light tan |
| | 80+ (new) | | | rice syrup | | | | 0.240 | to tan |
| R-671 | RemyPro | 65.64 | — | Tapioca | 22.97 | crisps | 5% max | 0.200- | Light tan |
| | 80+ (new) | | | starch | | | | 0.240 | to tan |
| | | | | Brown | 11.93 | | | | |
| | | | | rice syrup | | | | | |
| R-673 | RemyPro | 100 | — | — | — | crisps | 5% max | 0.260- | Light tan |
| | 80+ (new) | | | | | | | 0.300 | to tan |
| R-677 | RemyPro | 69.9 | 23.33 | Brown | 6.77 | crisps | 5% max | 0.265- | Light tan |
| | 80+ (new) | | | rice syrup | | | | 0.305 | to tan |

*for this run no product was collected—fat content was too high and unable to obtain satisfactory product.

### Example 3

### Hedonic Test

Tests on the various products were made with trained tasters, using a hedonic system on a scale of 1 to 10, level 1 being least palatable, and level 10 being the most palatable.

TABLE 2

| | Rice Protein | | | | | | | |
|---|---|---|---|---|---|---|---|---|
| | concentrate | Tester 1 | Tester 1 | Tester 1 | Tester 2 | Tester 2 | Tester 2 | Avg overall |
| Product | or isolate | Flavor | Shape | Overall | Flavor | Shape | Overall | score |
| R-371 | CNP 50% | 6 | 2 | 4 | 8 | 8 | 8 | 6 |
| | Pro | | | | | | | |
| R-431 | RemyPro | 5 | 5 | 5 | 2 | 8 | 2 | 3.5 |
| | 70+ | | | | | | | |
| R-490 | RemyPro | 4 | 3 | 3 | 6 | 2 | 3 | 3 |
| | 80+ (old) | | | | | | | |
| R-500 | RemyPro | 3 | 4 | 3 | 2 | 8 | 3 | 3 |
| | 80+ (old) | | | | | | | |
| R-521 | RemyPro | 3 | 3 | 3 | 7 | 2 | 3 | 3 |
| | 80+ (old) | | | | | | | |
| R-524 | RemyPro | 4 | 4 | 4 | 6 | 2 | 2 | 3 |
| | 80+ (old) | | | | | | | |
| R-564 | RemyPro | 3 | 5 | 3 | 3 | 7 | 4 | 3.5 |
| | 80+ (old) | | | | | | | |
| R-565 | RemyPro | 3 | 4 | 3 | 2 | 7 | 2 | 2.5 |
| | 80+ (old) | | | | | | | |
| R-566 | RemyPro | 4 | 6 | 4 | 3 | 6 | 4 | 4 |
| | 80+ (old) | | | | | | | |
| R-659 | RemyPro | 4 | 5 | 4 | 9 | 6 | 5 | 4.5 |
| | 80+ (new) | | | | | | | |
| R-667 | RemyPro | 6 | 7 | 6 | 5 | 8 | 7 | 6.5 |
| | 80+ (new) | | | | | | | |
| R-671 | RemyPro | 7 | 6 | 7 | 9 | 8 | 9 | 8 |
| | 80+ (new) | | | | | | | |
| R-673 | RemyPro | 5 | 4 | 4 | 8 | 5 | 6 | 5 |
| | 80+ (new) | | | | | | | |
| R-677 | RemyPro | 7 | 7 | 7 | 8 | 8 | 8 | 7.5 |
| | 80+ (new) | | | | | | | |

Although the foregoing invention has been described in some detail by way of illustration and example for purposes of clarity and understanding, it will be obvious that certain changes and modifications may be practiced within the scope of the invention, as limited only by the scope of the appended claims.

All references cited herein are hereby expressly incorporated herein by reference.

1. A textured food product having a rice protein content of between about 10% and about 90% by dry weight.

2. The product of claim 1 wherein the rice protein content is at least about 30% by dry weight.

3. The product of claim 2 wherein the rice protein content is at least about 50% by dry weight.

4. The product of claim 3 wherein the rice protein content is at least about 80% by dry weight.

5. The product of claim 1 wherein rice protein comprises about 50% or greater of the total protein content in said product.

6. The product of claim 1 having a density of between about 0.1 g/cc and about 0.4 g/cc and a moisture content of less than about 7%.

7. The product of claim 6 having a density of less than about 0.3 g/cc.

8. The product of claim 6 having a moisture content of less than about 5%.

9. The product of claim 1 comprising a rice protein ingredient selected from the group consisting of rice protein concentrates, rice protein isolates and mixtures thereof.

10. The product of claim 9 wherein said rice protein ingredient has a reduced hexanal of less than about 15,000 ppb, when measured through head space analysis.

11. The product of claim 10 wherein said rice protein ingredient has a reduced hexanal of less than about 10,000 ppb, when measured through head space analysis.

12. The product of claim 11 wherein said rice protein ingredient has a reduced hexanal of less than about 7,500 ppb, when measured through head space analysis.

13. The product of claim 9 comprising from about 40% to about 100% of said rice protein ingredient, by dry weight.

14. The product of claim 13 comprising about 60% or greater of said rice protein ingredient.

15. The product of claim 14 comprising about 75% or greater of said rice protein ingredient.

16. The product of claim 15 comprising about 90% or greater of said rice protein ingredient.

17. The product of claim 9 comprising a rice protein concentrate having at least about 70% rice protein.

18. The product of claim 17 comprising a rice protein concentrate having at least about 80% rice protein.

19. The product of claim 18 wherein said rice protein concentrate is Remypro N80+.

20. The product of claim 9 wherein said rice protein ingredient supplies substantially all of the rice protein in said product.

21. The product of claim 9 wherein said rice protein is predominantly insoluble rice protein.

22. The product of claim 21 wherein said rice-protein is a blend of soluble and insoluble rice proteins.

23. The product of claim 22 wherein said rice protein comprises from about 50% to about 90% insoluble rice protein.

24. The product of claim 9 further comprising a second protein-containing ingredient, wherein said second protein-containing ingredient is not a rice protein ingredient, and wherein said second protein-containing ingredient contributes about 50% or less of the total protein of said product.

25. The product of claim 24 wherein said second protein-containing ingredient is a high lysine containing ingredient.

26. The product of claim 25 wherein said high lysine containing ingredient is selected from the group consisting of protein powders, protein concentrates, protein isolates, high protein flours, purified lysine and mixtures thereof.

27. The product of claim 26 wherein said high lysine containing ingredient is a flour selected from the group consisting soybean flour, fava bean flour, lentil flour, pea flour, chickpea flour, lentil flour, lupin flour, quinoa flour, amaranth flour and mixtures thereof.

28. The product of claim 26 wherein said high lysine containing ingredient is selected from the group consisting of whey powder, whey concentrate, whey isolate, soy concentrate, soy isolate and mixtures thereof.

29. The product of claim 26 wherein said purified lysine is selected from the group consisting of lysine monohydrate salts.

30. The product of claim 29 wherein said lysine monohydrate salt is L-lysine monohydiochloride present at about 1% to about 8% of the product, by dry weight.

31. The product of claim 25 wherein lysine comprises between about 4% and about 10% of the total amino acids of said product.

32. The product of claim 31 wherein lysine comprises at least about 7% of the total amino acids of said product.

33. The product of claim 1 having low off flavor.

34. The product of claim 33 having very low off flavor.

35. The product of claim 34 having extremely low off flavor.

36. The product of claim 1 having low rancidity.

37. The product of claim 1 having a peroxide value of about 10 meq/kg or less.

38. The product of claim 35 having a peroxide value of about 5 meq/kg or less.

39. The product of claim 36 having a peroxide value of about 2 meq/kg or less.

40. The product of claim 1 having a hedonic test score of at least about 6 on a hedonic scale of 0 to 10.

41. The product of claim 40 having a hedonic test score of at least about 7.

42. The product of claim 41 having a hedonic test score of at least about 8.

43. The product of claim 1 further comprising from about 10% to about 70% by dry weight of carbohydrate.

44. The product of claim 43 wherein said carbohydrate is selected from the group consisting of starches and flours derived from grains, roots, corms, tubers and stems.

45. The product of claim 44 wherein said carbohydrate is selected from the group consisting of rice flour, rice starch, wheat flour, wheat starch, oat flour, tapioca starch, potato starch, corn starch and mixtures thereof.

46. The product of claim 43 wherein said carbohydrate comprises from about 5% to about1 5% by dry weight of a sweetener.

47. The product of claim 46 wherein said sweetener is selected from the group consisting of brown rice syrup, malt extract, honey and fruit juice concentrate.

48. The product of claim 1 wherein said carbohydrate comprises from about 1% to about 50% by dry weight of a dietary fiber.

49. The product of claim 1 wherein said protein is derived from rice having a trait selected from the group consisting of genetically engineered rice, organically grown rice and non-genetically modified rice.

50. A consumer product comprising the textured food product of claim 1, wherein said consumer product is selected from the group consisting of a ready to eat cereal, a snack product, a nutrition bar, a snack bar, an energy bar and a confectionary product.

51 through 56. (canceled)
